(19) United States
(12) Patent Application Publication
(10) Pub. No.: US 2019/0053124 A1
(43) Pub. Date: Feb. 14, 2019

(54) METHOD AND APPARATUS FOR ENABLING WIRELESS CONNECTION BASED ON RTT AND AOA

(71) Applicant: QUALCOMM Incorporated, San Diego, CA (US)

(72) Inventors: Suresh Kumar BITRA, Mangalagiri (IN); Manohar Kandagadla, Hyderabad (IN)

(21) Appl. No.: 15/675,563

(22) Filed: Aug. 11, 2017

(51) Int. Cl. H04W 48/04; H04W 24/08; H04L 12/26; H04W 76/02; H04W 12/06

(52) U.S. Cl. CPC H04W 48/04; H04W 24/08; H04W 88/08; H04W 76/02; H04W 12/06; H04L 43/0864

(57) ABSTRACT

A wireless access point enables or rejects a wireless connection request from a mobile device based on a round trip time (RTT) measurement and an angle of arrival (AoA) measurement for signals from the mobile device. After receiving a wireless connection request from the mobile device, the wireless access point obtains the RTT and the AoA measurements for the mobile device. The wireless access point determines if the RTT and the AoA measurements for the mobile device are within predefined RTT and AoA ranges that define a physical boundary with respect to the wireless access point. The wireless connection is accepted if the RTT and AOA measurements are within the predefined RTT and AoA ranges and are otherwise rejected. If desired, a plurality of physical boundaries may be used, each with different predefined RTT and AoA ranges, and each physical boundary may have a different predefined time limit range.

### BACKGROUND

### Background Field

The subject matter disclosed herein relates to electronic devices, and more particularly to methods and apparatuses for use in establishing a wireless connection between a mobile device and a wireless access point.

### Relevant Background

Wireless radio communications technology, such as Wi-Fi™ as defined by IEEE 802.11, has become an important medium for providing access to local area networks and internet connectivity in small public localities, such as shops, restaurants, etc., as well as in the home. In order to gain access to such wireless communications, a user typically is required to provide proper authentication, such as a password or security key. Enabling anyone with the password to access to a wireless connection, however, may be undesirable. For example, once a password is known, a user may access an establishment's wireless connection even when the user is not patronizing the establishment, or a child may access a home's wireless connection from a location without adult supervision. Moreover, restricting the access to a wireless connection based on a user's position requires typically requires a position determination with the user's mobile device, e.g., using GPS, which requires power intensive operations, may not be available on all devices, and may not be available or have the desired accuracy in indoor conditions.

### SUMMARY

A wireless access point enables or rejects a wireless connection request from a mobile device based on a round trip time (RTT) measurement and an angle of arrival (AoA) measurement for signals from the mobile device. After receiving a wireless connection request from the mobile device, the wireless access point obtains the RTT and the AoA measurements for the mobile device. The wireless access point determines if the RTT and the AoA measurements for the mobile device are within predefined RTT and AoA ranges that define a physical boundary with respect to the wireless access point. The wireless connection is accepted if the RTT and AOA measurements are within the predefined RTT and AoA ranges and are otherwise rejected. If desired, a plurality of physical boundaries may be used, each with different predefined RTT and AoA ranges, and each physical boundary may have a different predefined time limit range.

In one implementation, a method of enabling a wireless connection with a mobile device by a wireless access point includes receiving a wireless connection request from the mobile device; obtaining a round trip time (RTT) measurement for wireless signals between the wireless access point and the mobile device; obtaining an angle of arrival (AoA) measurement for the wireless signals from the mobile device; determining if the RTT measurement and the AoA measurement for the mobile device are within predefined RTT and AoA ranges that define a physical boundary with respect to the wireless access point; and accepting the wireless connection with the mobile device if the RTT measurement and the AoA measurement are determined to be within the predefined RTT and AoA ranges and rejecting the wireless connection with the mobile device if at least one of the RTT measurement or the AoA measurement is determined to be outside the predefined RTT and AoA ranges.

In one implementation, a wireless access point capable of enabling a wireless connection with a mobile device includes a wireless radio transceiver capable of wireless radio communications with a mobile device; and at least one processor coupled to the wireless radio transceiver, the at least one processor configured to receive a wireless connection request from the mobile device, obtaining a round trip time (RTT) measurement for wireless signals to and from the mobile device, obtain an angle of arrival (AoA) measurement for the wireless signals from the mobile device, determine if the RTT measurement and the AoA measurement for the mobile device are within predefined RTT and AoA ranges that define a physical boundary with respect to the wireless access point, and accept the wireless connection with the mobile device if the RTT measurement and the AoA measurement are determined to be within the predefined RTT and AoA ranges and reject the wireless connection with the mobile device if at least one of the RTT measurement or the AoA measurement is determined to be outside the predefined RTT and AoA ranges.

In one implementation, a wireless access point capable of enabling a wireless connection with a mobile device includes means for receiving a wireless connection request from the mobile device; means for obtaining a round trip time (RTT) measurement for wireless signals between the wireless access point and the mobile device; means for obtaining an angle of arrival (AoA) measurement for the wireless signals from the mobile device; means for determining if the RTT measurement and the AoA measurement for the mobile device are within predefined RTT and AoA ranges that define a physical boundary with respect to the wireless access point; and means for accepting the wireless connection with the mobile device if the RTT measurement and the AoA measurement are determined to be within the predefined RTT and AoA ranges and rejecting the wireless connection with the mobile device if the RT measurement and the AoA measurement are determined to be outside the predefined RTT and AoA ranges.

In one implementation, a non-transitory computer readable medium having stored therein computer executable instructions executable by one or more processing units of a wireless access point to enable a wireless connection with a mobile device, includes program code to receive a wireless connection request from the mobile device; program code to obtain a round trip time (RTT) measurement for wireless signals between the wireless access point and the mobile device; program code to obtain an angle of arrival (AoA) measurement for the wireless signals from the mobile device; program code to determine if the RTT measurement and the AoA measurement for the mobile device are within predefined RTT and AoA ranges that define a physical boundary with respect to the wireless access point; and program code to accept the wireless connection with the mobile device if the RTT measurement and the AoA measurement are determined to be within the predefined RTT and AoA ranges and reject the wireless connection with the mobile device if at least one of the RTT measurement or the AoA measurement is determined to be outside the predefined RTT and AoA ranges.

### BRIEF DESCRIPTION OF THE DRAWING

Non-limiting and non-exhaustive aspects are described with reference to the following figures, wherein like reference numerals refer to like parts throughout the various figures unless otherwise specified.

FIG. 1 is a diagram illustrating a wireless access point enabling a wireless connection, such as a Wi-Fi connection, with a mobile device based on round trip time (RTT) and angle of arrival (AoA) measurements.

FIG. 2 is a diagram illustrating a wireless access point positioned within a building having several rooms and being configured to define a plurality of physical boundaries using predefined RTT and AoA ranges.

FIG. 3 is a diagram illustrating a wireless access point configured with predefined RTT ranges and AoA ranges that define a three-dimensional physical boundary.

FIG. 4 is a diagram illustrating a process of using RTT measurements and AoA measurements to enable a wireless connection between a wireless access point and a mobile device.

FIG. 5 is a flow chart illustrating a process of enabling a wireless connection with a mobile device by a wireless access point based on RTT and AoA measurements.

FIG. 6 is a block diagram of a wireless access point configured to enable a wireless connection with a mobile device based on RTT and AoA measurements.

### DETAILED DESCRIPTION

A wireless access point may enable or reject a wireless connection request from a mobile device based on whether a round trip time (RTT) measurement and an angle of arrival (AoA) measurement for signals from the mobile device are within predefined RTT and AoA ranges that define a physical boundary. For example, an establishment, such as a store or coffee shop, or home may define physical boundaries using RTT and AoA ranges from a wireless access point, and may permit a mobile device to access a wireless connection with the wireless access point only when both the RTT and AoA measurements are within those predefined RTT and AoA ranges. Accordingly, connection to the wireless access point can be advantageously controlled without requiring power intensive operations, such as positioning, from the user's mobile device. Further, time limitations may be associated with the predefined RTT and AoA ranges, e.g., so that wireless connections with mobile devices within the predefined RTT and AoA ranges may be restricted to specific times. Additionally, multiple physical boundaries, e.g., specific rooms within an establishment or home, may be defined using different RTT and AoA ranges, and wireless connectivity may be limited to specific RTT and AoA ranges or the time or type of wireless connectivity may be controlled based on the different RTT and AoA ranges.

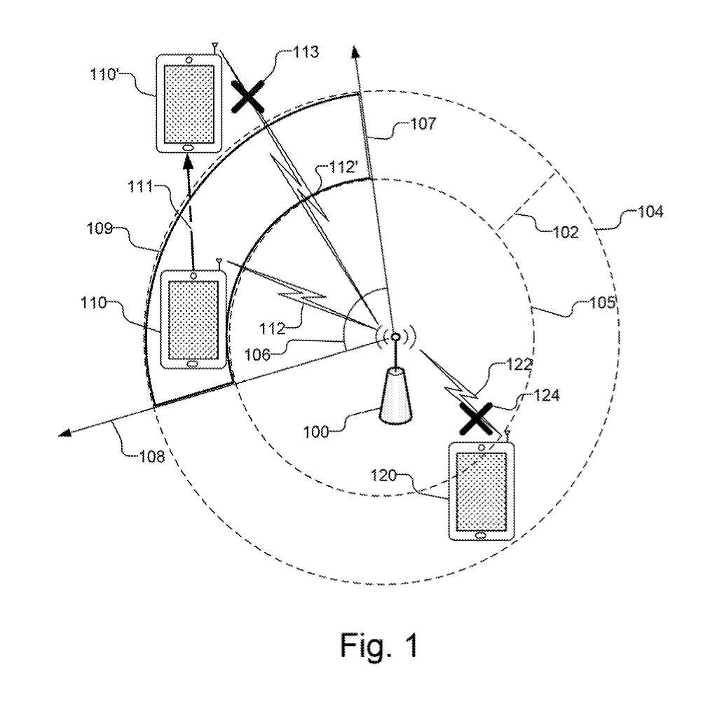

FIG. 1 is a diagram illustrating wireless access point 100 enabling a wireless connection, such as a Wi-Fi connection defined by IEEE 802.11, with a mobile device 110 based on round trip time (RTT) measurements and angle of arrival (AoA) measurements. The wireless access point 100, for example, may be configured with predefined RTT and AoA ranges that define a physical boundary with respect to the wireless access point. For example, a predefined RTT range 102 produces an area around the wireless access point 100 illustrated by circles 104, 105 representing different RTTs with respect to the wireless access point 100. A predefined AoA range 106 is illustrated by the lines 107, 108 representing different AoA with respect to the wireless access point 100. Thus, the predefined RTT and AoA ranges 102 and 106 define a physical boundary 109, illustrated as an area with solid lines in FIG. 1. If desired, the predefined RTT and AoA ranges 102 and 106 may define a three-dimensional physical boundary, which would be a volume.

The wireless access point 100, may be may be part of a local area network (LAN) and may be, e.g., a router, a bridge, a repeater, etc. serving a Wi-Fi defined by IEEE 802.11 network. The mobile device 110 may be referred to as devices, wireless devices, mobile terminals, terminals, mobile stations (MSs), user equipment (UE) or by some other name and may correspond to a cellphone, smartphone, laptop, tablet, PDA, tracking device or some other portable or moveable device that is capable of wireless radio communications, e.g., such as Wi-Fi defined by IEEE 802.11.

Prior to enabling a wireless connection with mobile device 110, the wireless access point 100 obtains RTT measurements for wireless signals between the wireless access point 100 and the mobile device 110 and obtains AoA measurements for wireless signals from the mobile device 110. The wireless access point 100 may compare the RTT and AoA measurements to the predefined RTT and AoA ranges to determine if a wireless connection with the mobile device should be enabled. As illustrated in FIG. 1, mobile device 110 is within the physical boundary 109, and, thus, the RTT and AoA measurements for the mobile device 110 will be within the predefined RTT and AoA ranges 102 and 106. Accordingly, the wireless access point 100 may enable the wireless connection 112 with the mobile device 110. If desired, the wireless access point 100 may require additional authentication information, such as a password or security key, before enabling the wireless connection 112.

In comparison, as illustrated in FIG. 1 the mobile device 120 is within the RTT range 102, but is outside the AoA range 106, and therefore is outside the physical boundary 109. Accordingly, the RTT and AoA measurements for the mobile device 120 obtained by the wireless access point 100 will not be within the predefined RTT and AoA ranges 102 and 106 and, consequently, the wireless connection 122 with the mobile device 120 is rejected, as illustrated by the “X” 124. It should be understood that if a mobile device is within the AoA range 106, but outside the RTT range 102 or outside both the AoA range 106 and the RTT range 102, the wireless connection with that mobile device would likewise be rejected.

Once the wireless connection 112 with the mobile device 110 is established, the wireless access point 100 may periodically evaluate whether the wireless connection 112 should be maintained. For example, the wireless access point 100 may periodically obtain RTT and AoA measurements from the mobile device 110 and maintain the wireless connection 112 while the RTT and AoA measurements are within the predefined RTT and AoA ranges 102 and 106. If the mobile device 110 is moved, as illustrated by line 111, to a location that is not within the physical boundary 109, e.g., as illustrated by mobile device 110′, the RTT and AoA measurements will no longer be within the predefined RTT and AoA ranges 102 and 106. Accordingly, the wireless access point 100 may disconnect the wireless connection 112′ with the mobile device 110′, as illustrated by the “X” 113.

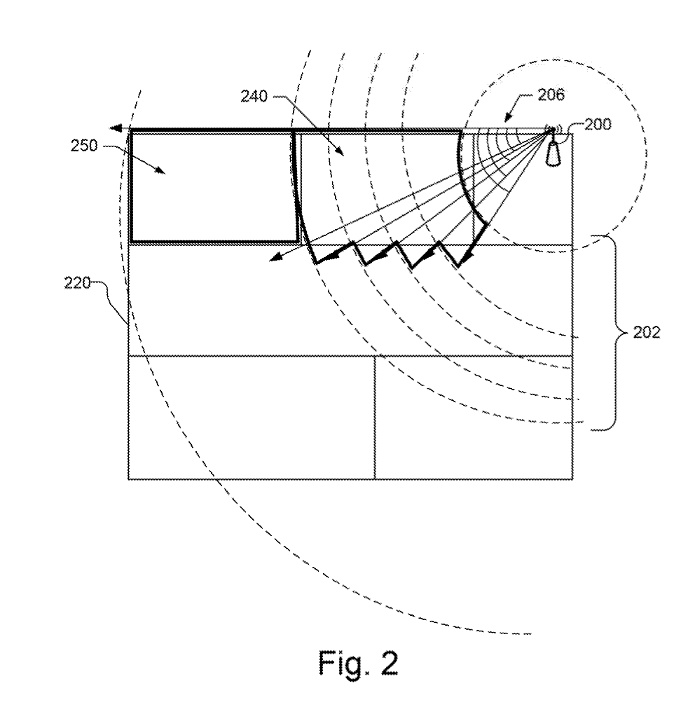

FIG. 2 illustrates a wireless access point 200 positioned within a building 220 having several rooms and is configured with a plurality of predefined RTT and AoA ranges. As illustrated, the plurality of predefined RTT and AoA ranges may define multiple physical boundaries, illustrated as areas 240 and 250. For example, the physical boundary 240 is defined using a plurality of AoA ranges 206 and an associated plurality of RTT ranges 202. With the use of an appropriate number and configuration of AoA ranges 206 and associated RTT ranges 202, the physical boundary 240 may approximate any desired geometry, e.g., rectangle, circle, etc. For example, the AoA ranges and associated RTT ranges (not shown) associated with physical boundary 250 may be sufficient to approximate a rectangle as illustrated. Moreover, as can be seen in FIG. 2, the physical boundaries defined by the predefined RTT and AoA ranges need not include the location of the wireless access point 200 itself, but if desired, may include the wireless access point 200.

By configuring multiple physical boundaries using different predefined RTT and AoA ranges, the wireless access point 200 may be configured to control the wireless connection to mobile devices in different locations of the building 220 in different ways. For example, it may be desirable to control wireless connections at different locations based on time. Accordingly, different predefined RTT and AoA ranges may be associated with different predefined time limit ranges that limit the times that wireless connections will be accepted by the wireless access point 200, e.g., the predefined RTT and AoA ranges that define physical boundary 240 may be associated with a time limit range of 8 am to 8 pm, while the predefined RTT and AoA ranges that define physical boundary 250 may be associated with no time limit range. Additionally or alternatively, the type of wireless connection may be modified based on location. For example, for a mobile device within the predefined RTT and AoA ranges that define physical boundary 240, the wireless access point 200 may enable a wireless connection to a local area network but provide no internet access, or may apply specific rules or filters to the internet access or wireless connection. For a mobile device within the predefined RTT and AoA ranges that define physical boundary 250, on the other hand, the wireless access point 200 may provide full internet access or may apply other rules or filters.

The wireless access point 200 may be configured with the RTT and AoA ranges to define desired physical boundaries through a calibration procedure. For example, a user may calibrate the wireless access point 200 by moving a mobile device around a desired physical boundary, e.g., the perimeter of a room, while the wireless access point 200 measures and records the RTT and AoA measurements. The resulting ranges in the RTT and AoA measurements may be used as the predetermined RTT and AoA ranges that define the physical boundary.

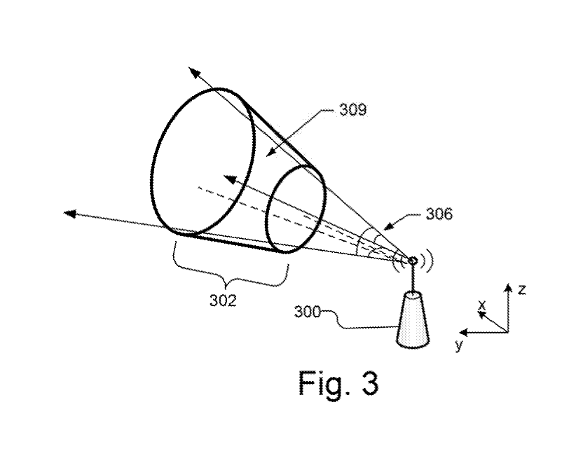

FIG. 3 illustrates a wireless access point 300 that is configured with predefined RTT ranges 302 and AoA ranges 306 that define a three-dimensional physical boundary 309. By defining a three-dimensional physical boundary, the wireless access point 300 may control wireless connections within physical boundaries, e.g., that are on different floors than the wireless access point. Similar to the two-dimensional physical boundaries discussed in reference to FIG. 2, with a sufficient number of predefined RTT ranges 302 and AoA ranges 306, the three-dimensional physical boundaries may approximate various desired physical geometries, including cube, sphere, etc.

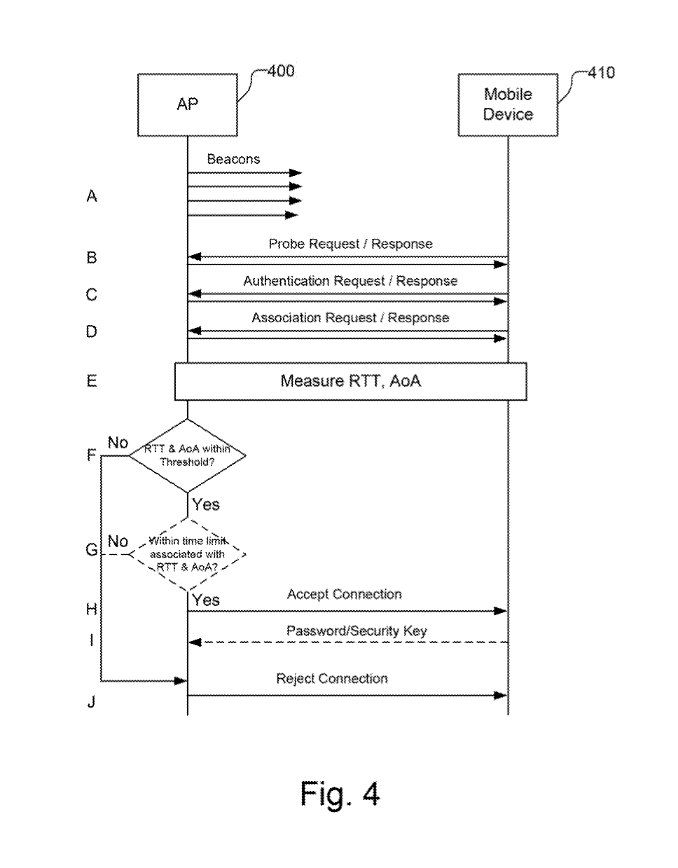

FIG. 4 illustrates a process of using RTT measurements and AoA measurements to enable a wireless connection, such as a Wi-Fi connection defined by IEEE 802.11, between a wireless access point 400 and mobile device 410. As illustrated, the wireless access point 400 may periodically transmit beacons announcing the presence of a wireless local access network (WLAN) in step A. In step B, the mobile device 410 may transmit a probe request, e.g., with supported data rates and capabilities, and in response, the wireless access point 400 provides a probe response, e.g., with the SSID (wireless network name), supported data rates, encryption types if required, and other capabilities. In step C, the mobile device 410 may transmit an authentication request and in response the wireless access point 400 provides an authentication response and in step D, the mobile device 410 may transmit an association request and in response the wireless access point 400 provides an association response. If the wireless access point 400 does not accept the association, the wireless access point 400 may provide a failure status in the association response in step D. In IEEE 802.11, the authentication request in step C is not the same as a password or security key used as authentication mechanisms, which may occur after mobile device 410 is authenticated and associated, e.g., in step I, discussed below.

The wireless access point 400 may then obtain the RTT and AoA of signals from the mobile device in step E. For example, the wireless access point 400 may measure the RTT and AoA of signals from the mobile device. Alternatively, the mobile device 410 may measure one or more of the RTT and AoA of signals from the wireless access point 400 and provide those measurements to the wireless access point 400. The RTT measurement is the length of time between a signal being transmitted and acknowledgement of that signal being received, i.e., the propagation times between two points. As the wireless signals travel at a known velocity, the RTT measurement is a measure of the distance between the wireless access point 400 and the mobile device 410. The AoA measurement is the angle of arrival of a signal received at an antenna array. For example, the phase-shift difference of the received signal arriving at antennas separated by a known distance in the antenna array, may be used compute the angle of arrival of the signal with respect to normal of the antenna array.

The wireless access point 400 may then determine if the RTT and AoA measurements are within a threshold of the predefined RTT and AoA ranges in Step F. If the RTT and AoA measurements are within the threshold of the predefined RTT and AoA, the wireless access point 400 may accept the wireless connection with the mobile device 410, thereby granting network access to the mobile device in step H. Optionally, after the mobile device is associated in step H, an authentication mechanism, such as a password or security key, may be provided by the mobile device 410 in step I, in order to obtain access to the network. If one or more of the RTT and AoA measurements is not within the threshold of the predefined RTT and AoA, the wireless access point 400 may reject the wireless connection with the mobile device 410, thereby denying network access in step J.

The wireless connection enabled by the wireless access point 400 may include limitations associated with the predefined RTT and AoA ranges. For example, the specific rules or filters may be associated with the predefined RTT and AoA ranges and may be applied to the wireless connection with the mobile device 410. Additionally, an optional step G may be used to determine whether the time is within a predefined time limit range associated with the predefined RTT and AoA ranges. As illustrated, if the current time is within the time limit range, the wireless connection may be is accepted in step H, and is otherwise rejected in step J.

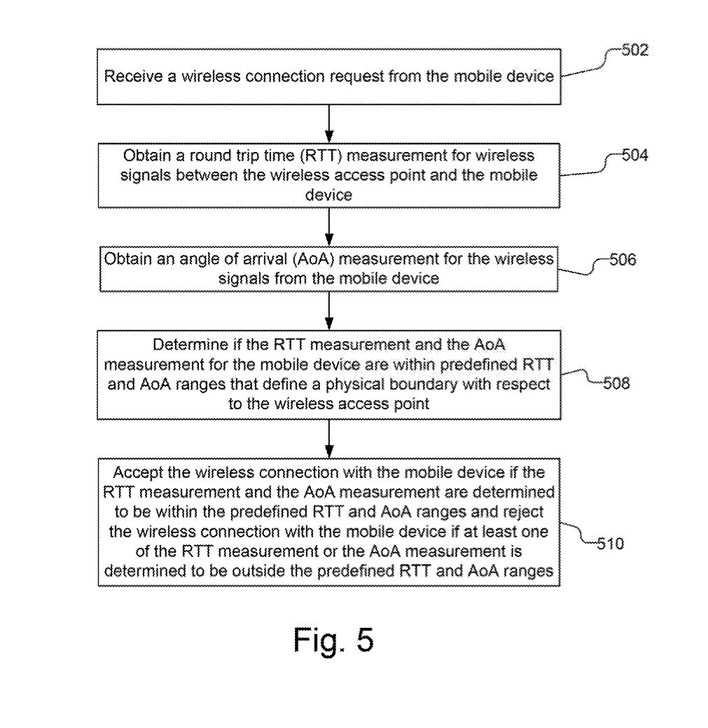

FIG. 5 is a flow chart illustrating a process of enabling a wireless connection with a mobile device by a wireless access point. As illustrated, a wireless connection request is received from the mobile device (502). For example, the wireless connection request may be a request for a Wi-Fi connection defined by IEEE 802.11. The wireless access point may obtain a round trip time (RTT) measurement for wireless signals between the wireless access point and the mobile device (504). The RTT measurement may be measured by the wireless access point or may be measured by the mobile device and the resulting RTT measurement transmitted to the wireless access point. The wireless access point may also obtain an angle of arrival (AoA) measurement for the wireless signals from the mobile device (506). Again, the AoA measurement may be measured by the wireless access point or may be measured by the mobile device and the resulting AoA measurement transmitted to the wireless access point, where the resulting AoA measurement is relative to a fixed coordinate system.

The wireless access point may determine if the RTT measurement and the AoA measurement for the mobile device are within predefined RTT and AoA ranges that define a physical boundary with respect to the wireless access point (508). The physical boundary with respect to the wireless access point that is defined by the predefined RTT and AoA ranges may be a three-dimensional physical boundary and may define geometric shapes, such as a sphere, cube, etc. The physical boundary with respect to the wireless access point may not include the location of the wireless access point. Further, there may be a plurality of physical boundaries defined by different predefined RTT and AoA ranges. Moreover, different physical boundaries in the plurality of physical boundaries may be associated with different predefined time limit ranges that limit times that wireless connections will be accepted by the wireless access point. The predefined RTT and AoA ranges that define the physical boundary with respect to the wireless access point may be produced by obtaining RTT measurements and AoA ranges from a calibrating mobile device, e.g., the mobile device of a user, as the calibrating mobile device is moved around the physical boundary, e.g., moved along the perimeter of the physical boundary.

As illustrated in FIG. 5, the wireless access point may accept the wireless connection with the mobile device if the RTT measurement and the AoA measurement are determined to be within the predefined RTT and AoA ranges and rejecting the wireless connection with the mobile device if at least one of the RTT measurement or the AoA measurement is determined to be outside the predefined RTT and AoA ranges (510). Additionally, if desired, the wireless access point may require authentication information, such as a password or security key, from the mobile device prior to accepting the wireless connection. Additionally, the wireless access point may periodically obtain a new RTT measurement and a new AoA measurement and disconnect the wireless connection with the mobile device if at least one of the new RTT measurement and the new AoA measurement is determined to be outside the predefined RTT and AoA ranges.

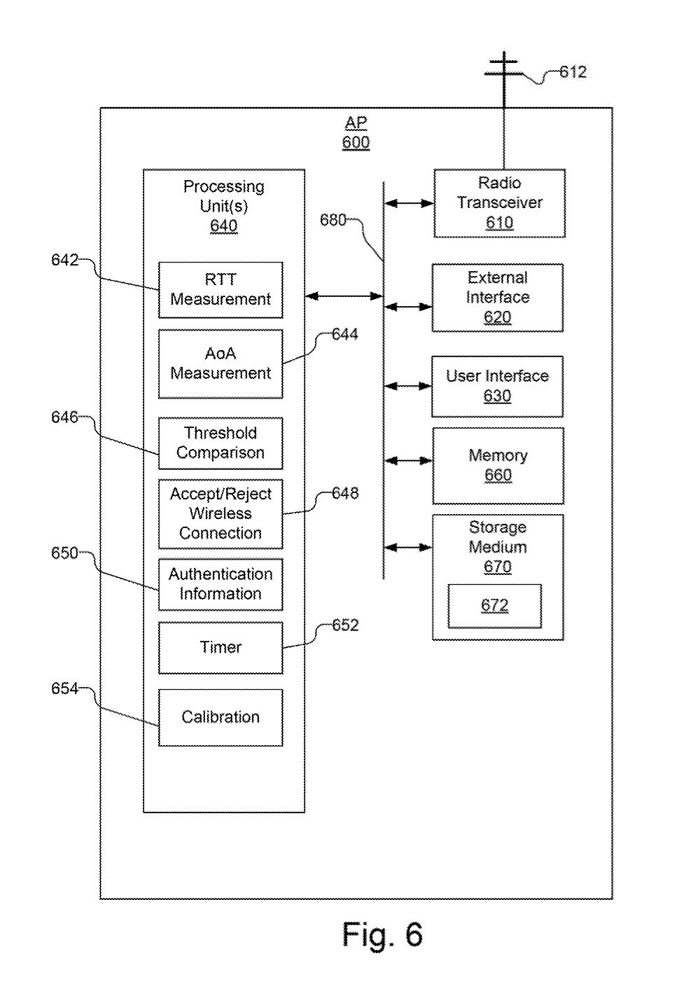

FIG. 6 is a block diagram of a wireless access point 600 configured to enable a wireless connection with a mobile device based on RTT and AoA measurements. The wireless access point 600 includes a wireless radio transceiver 610, including a transmitter and receiver, capable of wireless radio communications with a mobile device, such as a Wi-Fi connection defined by IEEE 802.11. The wireless access point 600 includes an antenna array 612, which may be internal or external and is coupled to the wireless radio transceiver 610 to transmit and/or receive wireless radio signals. The wireless access point 600 may further includes an external interface 620, which may be a wired or wireless interface capable of connecting to a local area network and/or the internet. The wireless access point 600 may be configured via external interface 620, but may also include a user interface 630 through which the wireless access point 600 may be configured.

The wireless access point 600 may include, for example, one or more processing units 640, memory 660, and storage medium 670, which may be operatively coupled with one or more connections 680 (e.g., buses, lines, fibers, links, etc.). The radio transceiver 610, external interface 620, and user interface 630 (if present) may similarly be coupled together with connections 680, or separate connections. In certain example implementations, some portion of the wireless access point 600 may take the form of a chipset, and/or the like.

Processing unit 640 may be implemented using a combination of hardware, firmware, and software. For example, processing unit 640 may include one or more processing units configured to perform the functions discussed herein by implementing one or more instructions or program code 672 on a non-transitory computer-readable medium, such as storage medium 670 and/or memory 660. In some embodiments, processing unit 640 may represent one or more circuits configurable to perform at least a portion of the processes related to the wireless access point 600. In some embodiments, processing unit 640 may include an RTT measurement unit 642 that is configured to measure the RTT to a mobile device as discussed above, e.g., by causing the radio transceiver 610 to transmit a signal to the mobile device and to monitor the time until the radio transceiver 610 receives an acknowledgement from the mobile device. The processing unit 640 may further include an AoA measurement unit 644 that is configured to determine the angle of arrival of a signal received at the antenna array 612, e.g., based on the phase-shift difference of the received signal arriving at antennas in the antenna array that are separated by a known distance. The processing unit 640 may further include a threshold comparison unit 646 that is configured to compare the RTT measurement and AoA measurement from a mobile device to predefined RTT and AoA ranges, e.g., that are stored in memory 660 or storage medium 670, to determine if the RTT measurement and AoA measurement are within or outside the predefined RTT and AoA ranges. An accept/reject wireless connection unit 648 is configured to accept a wireless connection with the mobile device if the RTT measurement and the AoA measurement are determined to be within the predefined RTT and AoA ranges, e.g., by granting network access to the mobile device, or to reject the wireless connection if at least one of the RTT measurement or the AoA measurement is determined to be outside the predefined RTT and AoA ranges, e.g., by not permitting network access to the mobile device. The processing unit 640 may further include an authentication information unit 650, which requires additional authentication information, such as a password or security key, from the mobile device via the radio transceiver 610 in order for the wireless connection to be accepted. The processing unit 640 may further include a timer unit 652 that includes a clock or monitors a clock (not shown) and is configured to cause the various processing units 642, 644, 646, and 648 to periodically obtain new RTT and AoA measurements and to disconnect the wireless connection with the mobile device if at least one of the new RTT or AoA measurements is determined to be outside the predefined RTT and AoA ranges. The processing unit 640 may further include a calibration unit 654 causes multiple measurements of RTT and AoA to be obtained from RTT measurement unit 642 and AoA measurement unit 644 and stored, e.g., in storage medium 670 while a calibrating mobile device is moved around a desired physical boundary in order to define the physical boundary with predefined RTT and AoA ranges.

The methodologies described herein in flow charts and message flows may be implemented by various means depending upon the application. For example, these methodologies may be implemented in hardware, firmware, software, or any combination thereof. For a hardware implementation, the processing unit 640 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software may be stored on a non-transitory computer-readable medium, such as storage medium 670 and/or memory 660. Program code 672 may be resident on non-transitory computer readable media, e.g., storage medium 670 or memory 660 and may be read and executed by processing units 640. Memory may be implemented within processing units 640 or external to processing units 640. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable medium, e.g., storage medium 670 and/or memory 660. Examples include computer-readable media encoded with a data structure and computer-readable media encoded with a computer program. For example, non-transitory computer-readable medium, e.g., storage medium 670 including program code 672 stored thereon, may include program code to support RTT and AoA measurements and comparison to a threshold to determine if wireless connection is accepted in a manner consistent with disclosed embodiments.

Non-transitory computer-readable media includes a variety of physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Other embodiments of non-transitory computer readable media include flash drives, USB drives, solid state drives, memory cards, etc. Combinations of the above should also be included within the scope of computer-readable media.

In addition to storage on computer readable medium, instructions and/or data may be provided as signals on transmission media to external interface 620, which may store the instructions/data in memory 660, storage medium 670 and/or relayed the instructions/data to processing units 640 for execution. For example, external interface 620 may receive wireless or network signals indicative of instructions and data. The instructions and data are configured to cause one or more processors to implement the functions outlined herein. That is, the communication apparatus includes transmission media with signals indicative of information to perform disclosed functions.

Memory 660 may represent any data storage mechanism. Memory 660 may include, for example, a primary memory and/or a secondary memory. Primary memory may include, for example, a random access memory, read only memory, non-volatile RAM, etc. While illustrated in this example as being separate from processing unit 640, it should be understood that all or part of a primary memory may be provided within or otherwise co-located/coupled with processing unit 640. Secondary memory may include, for example, the same or similar type of memory as primary memory and/or storage medium 670 such as one or more data storage devices including, for example, hard disk drives, optical disc drives, tape drives, a solid state memory drive, etc.

In certain implementations, secondary memory may be operatively receptive of, or otherwise configurable to couple to a non-transitory computer-readable medium, such as storage medium 670. As such, in certain example implementations, the methods and/or apparatuses presented herein may take the form in whole or part of a non-transitory computer readable medium, such as storage medium 670, that may include program code 672 with computer implementable instructions stored thereon, which if executed by at least one processing unit 640 may be operatively enabled to perform all or portions of the example operations as described herein. Program code 672 may be stored in memory 660 as well.

In certain implementations, a wireless access point capable of enabling a wireless connection with a mobile device may include means for receiving a wireless connection request from the mobile device, which may be, e.g., a radio transceiver 610 and antenna 612. A means for obtaining a round trip time (RTT) measurement for wireless signals between the wireless access point and the mobile device may be, e.g., the radio transceiver 610 and RTT measurement unit 642. A means for obtaining an angle of arrival (AoA) measurement for the wireless signals from the mobile device may be, e.g., the radio transceiver 610 and antenna 612 and the AoA measurement unit 644. A means for determining if the RTT measurement and the AoA measurement for the mobile device are within predefined RTT and AoA ranges that define a physical boundary with respect to the wireless access point may be, e.g., the threshold comparison unit 646. A means for accepting the wireless connection with the mobile device if the RTT measurement and the AoA measurement are determined to be within the predefined RTT and AoA ranges and rejecting the wireless connection with the mobile device if the RTT measurement and the AoA measurement are determined to be outside the predefined RTT and AoA ranges may be, e.g., the Accept/Reject wireless connection unit 648. The wireless access point may further include a means for requiring authentication information from the mobile device prior to accepting the wireless connection, which may be, e.g., the authentication information unit 650. The wireless access point may further include a means for periodically obtaining a new RTT measurement and a new AoA measurement and means for disconnecting the wireless connection with the mobile device if at least one of the new RTT measurement and the new AoA measurement is determined to be outside the predefined RTT and AoA ranges, which may include the timer unit 652, as well as the radio transceiver 610 and antenna 612, the RTT measurement unit 642, the AoA measurement unit 644, the threshold comparison unit 646, and the Accept/Reject wireless connection unit 648. The wireless access point may further include a means for calibrating the predefined RTT and AoA ranges that define the physical boundary with respect to the wireless access point by obtaining RTT measurements and AoA measurements from a calibrating mobile device as the calibrating mobile device is moved around the physical boundary, which may include, e.g., the calibration unit 654, as well as the radio transceiver 610 and antenna 612, the RTT measurement unit 642, the AoA measurement unit 644.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method of enabling a wireless connection with a mobile device by a wireless access point, the method comprising:
receiving a wireless connection request from the mobile device;
obtaining a round trip time (RTT) measurement for wireless signals between the wireless access point and the mobile device;
obtaining an angle of arrival (AoA) measurement for the wireless signals from the mobile device;
determining if the RTT measurement and the AoA measurement for the mobile device are within predefined RTT and AoA ranges that define a physical boundary with respect to the wireless access point; and
accepting the wireless connection with the mobile device if the RTT measurement and the AoA measurement are determined to be within the predefined RTT and AoA ranges and rejecting the wireless connection with the mobile device if at least one of the RTT measurement or the AoA measurement is determined to be outside the predefined RTT and AoA ranges.

2. The method of claim 1, further comprising requiring authentication information from the mobile device prior to accepting the wireless connection.

3. The method of claim 1, wherein after accepting the wireless connection with the mobile device, the method further comprising periodically obtaining a new RTT measurement and a new AoA measurement and disconnecting the wireless connection with the mobile device if at least one of the new RTT measurement and the new AoA measurement is determined to be outside the predefined RTT and AoA ranges.

4. The method of claim 1, wherein the physical boundary with respect to the wireless access point that is defined by the predefined RTT and AoA ranges is a three-dimensional physical boundary.

5. The method of claim 1, wherein the physical boundary with respect to the wireless access point does not include a location of the wireless access point.

6. The method of claim 1, wherein there are a plurality of physical boundaries defined by different predefined RTT and AoA ranges.

7. The method of claim 6, wherein different physical boundaries in the plurality of physical boundaries are associated with different predefined time limit ranges that limit times that wireless connections will be accepted by the wireless access point.

8. The method of claim 1, wherein the predefined RTT and AoA ranges that define the physical boundary with respect to the wireless access point are produced by obtaining RTT measurements and AoA measurements from a calibrating mobile device as the calibrating mobile device is moved around the physical boundary.

9. A wireless access point capable of enabling a wireless connection with a mobile device, the wireless access point comprising:
a wireless radio transceiver capable of wireless radio communications with a mobile device; and
at least one processor coupled to the wireless radio transceiver, the at least one processor configured to receive a wireless connection request from the mobile device, obtain a round trip time (RTT) measurement for wireless signals to and from the mobile device, obtain an angle of arrival (AoA) measurement for the wireless signals from the mobile device, determine if the RTT measurement and the AoA measurement for the mobile device are within predefined RTT and AoA ranges that define a physical boundary with respect to the wireless access point, and accept the wireless connection with the mobile device if the RTT measurement and the AoA measurement are determined to be within the predefined RTT and AoA ranges and reject the wireless connection with the mobile device if at least one of the RTT measurement or the AoA measurement is determined to be outside the predefined RTT and AoA ranges.

10. The wireless access point of claim 9, wherein the at least one processor is further configured to require authentication information from the mobile device prior to accepting the wireless connection.

11. The wireless access point of claim 9, wherein the at least one processor is further configured to periodically obtain a new RTT measurement and a new AoA measurement and to disconnect the wireless connection with the mobile device if at least one of the new RTT measurement and the new AoA measurement is determined to be outside the predefined RTT and AoA ranges.

12. The wireless access point of claim 9, wherein the physical boundary with respect to the wireless access point that is defined by the predefined RTT and AoA ranges is a three-dimensional physical boundary.

13. The wireless access point of claim 9, wherein the physical boundary with respect to the wireless access point does not include a location of the wireless access point.

14. The wireless access point of claim 9, wherein there are a plurality of physical boundaries defined by different predefined RTT and AoA ranges.

15. The wireless access point of claim 14, wherein different physical boundaries in the plurality of physical boundaries are associated with different predefined time limit ranges that limit times that wireless connections will be accepted by the wireless access point.

16. The wireless access point of claim 9, wherein the at least one processor is further configured to calibrate the predefined RTT and AoA ranges that define the physical boundary with respect to the wireless access point by being configured to obtain RTT measurements and AoA measurements from a calibrating mobile device as the calibrating mobile device is moved around the physical boundary.

17. A wireless access point capable of enabling a wireless connection with a mobile device, the wireless access point comprising:
means for receiving a wireless connection request from the mobile device;
means for obtaining a round trip time (RTT) measurement for wireless signals between the wireless access point and the mobile device;
means for obtaining an angle of arrival (AoA) measurement for the wireless signals from the mobile device;
means for determining if the RTT measurement and the AoA measurement for the mobile device are within predefined RTT and AoA ranges that define a physical boundary with respect to the wireless access point; and
means for accepting the wireless connection with the mobile device if the RTT measurement and the AoA measurement are determined to be within the predefined RTT and AoA ranges and rejecting the wireless connection with the mobile device if the RTT measurement and the AoA measurement are determined to be outside the predefined RTT and AoA ranges.

18. The wireless access point of claim 17, further comprising means for requiring authentication information from the mobile device prior to accepting the wireless connection.

19. The wireless access point of claim 17, further comprising means for periodically obtaining a new RTT measurement and a new AoA measurement and means for disconnecting the wireless connection with the mobile device if at least one of the new RTT measurement and the new AoA measurement is determined to be outside the predefined RTT and AoA ranges.

20. The wireless access point of claim 17, wherein the physical boundary with respect to the wireless access point that is defined by the predefined RTT and AoA ranges is a three-dimensional physical boundary.

21. The wireless access point of claim 17, wherein the physical boundary with respect to the wireless access point does not include a location of the wireless access point.

22. The wireless access point of claim 17, wherein there are a plurality of physical boundaries defined by different predefined RTT and AoA ranges, and wherein different physical boundaries in the plurality of physical boundaries are associated with different predefined time limit ranges that limit times that wireless connections will be accepted by the wireless access point.

23. The wireless access point of claim 17, further comprising a means for calibrating the predefined RTT and AoA ranges that define the physical boundary with respect to the wireless access point by obtaining RTT measurements and AoA measurements from a calibrating mobile device as the calibrating mobile device is moved around the physical boundary.

24. A non-transitory computer readable medium having stored therein computer executable instructions executable by one or more processing units of a wireless access point to enable a wireless connection with a mobile device, the computer executable instructions comprising
program code to receive a wireless connection request from the mobile device;
program code to obtain a round trip time (RTT) measurement for wireless signals between the wireless access point and the mobile device;
program code to obtain an angle of arrival (AoA) measurement for the wireless signals from the mobile device;
program code to determine if the RTT measurement and the AoA measurement for the mobile device are within predefined RTT and AoA ranges that define a physical boundary with respect to the wireless access point; and
program code to accept the wireless connection with the mobile device if the RTT measurement and the AoA measurement are determined to be within the predefined RTT and AoA ranges and reject the wireless connection with the mobile device if at least one of the RTT measurement or the AoA measurement is determined to be outside the predefined RTT and AoA ranges.

25. The non-transitory computer readable medium of claim 24, further comprising program code to require authentication information from the mobile device prior to accepting the wireless connection.

26. The non-transitory computer readable medium of claim 24, further comprising program code to periodically obtain a new RTT measurement and a new AoA measurement and to disconnect the wireless connection with the mobile device if at least one of the new RTT measurement and the new AoA measurement is determined to be outside the predefined RTT and AoA ranges.

27. The non-transitory computer readable medium of claim 24, wherein the physical boundary with respect to the wireless access point that is defined by the predefined RTT and AoA ranges is a three-dimensional physical boundary.

28. The non-transitory computer readable medium of claim 24, wherein the physical boundary with respect to the wireless access point does not include a location of the wireless access point.

29. The non-transitory computer readable medium of claim 24, wherein there are a plurality of physical boundaries defined by different predefined RTT and AoA ranges, and wherein different physical boundaries in the plurality of physical boundaries are associated with different predefined time limit ranges that limit times that wireless connections will be accepted by the wireless access point.

30. The non-transitory computer readable medium of claim 24, further comprising program code to calibrate the predefined RTT and AoA ranges that define the physical boundary with respect to the wireless access point by obtaining RTT measurements and AoA measurements from a calibrating mobile device as the calibrating mobile device is moved around the physical boundary.
